(19) United States
(12) Patent Application Publication
(10) Pub. No.: US 2013/0159892 A1
(43) Pub. Date: Jun. 20, 2013

(54) NON-TECHNICAL CREATION OF MOBILE WEB APPLICATIONS

(71) Applicants: Kika Suraj, Stonygate (GB); Andrew Perkins, Shepshed (GB)

(72) Inventors: Kika Suraj, Stonygate (GB); Andrew Perkins, Shepshed (GB)

(73) Assignee: WEEJOT LTD., Leicester (GB)

(21) Appl. No.: 13/585,699

(22) Filed: Aug. 14, 2012

Related U.S. Application Data
(60) Provisional application No. 61/575,192, filed on Aug. 17, 2011.

(51) Int. Cl. G06F 3/048

(52) U.S. Cl. CPC G06F 3/048
USPC 715/762

(57) ABSTRACT

An authoring and configuration interface for the creation and management of mobile-optimized web app-templates to publish functional programs or applications represented by icons to mobile websites without the need to understand or access computer code. Creation and modification of app-templates is managed non-technically through an app studio that also allows management of design themes and styling. Each app-template uses content and data and is configured non-technically through a series of specific properties relevant to the particular app-template's functionality. By delivering functionality through adopting a collection of documented mobile web standards, end users can view functionality deployed non-technically by administrators without needing to download native apps that are stored locally on a mobile device, with management, delivery, and consumption achieved through a server based application within a cloud-based software as a service architecture.

### CROSS-REFERENCE TO RELATED APPLICATION

This application claims priority to U.S. provisional application Ser. No. 61/575,192, filed Aug. 17, 2011, which is hereby incorporated by reference in its entirety.

### FIELD OF THE INVENTION

Non-technical building, configuration, and delivery of Internet or Worl-Wide-Web applications (“web-apps”), to be loaded onto and used on smartphones and similar devices, to provide easy preparing and publishing of such apps in a web browser interface, ready for end user consumption upon smartphone and tablet computers, without the need to write, edit, or use technical code in or through an application server.

### BACKGROUND OF THE INVENTION

The growth in use of smartphones, mobile devices, tablet computers, and the like within recent years has made applications or “web-apps” popular consumer and business products. Typically, such devices require apps developed by Software Engineers specifically aimed at each type and brand of device or the operating system used therein. Users can download such apps to their local device(s), either purchased or for free from the applicable Application store for their chosen device, such as Apple's AppStore (for iOS devices), Google's Play (for Android devices), BlackBerry's AppWorld (for all modern Blackberry devices), Microsoft's MarketPlace (for Windows phones), and so on.

First, an end user must locate the existence of an organization's app, either through one of these app stores directly, or via manual promotion of the app from the organization's own web presence. Of course, the end user may simply not realize that an organization has a specific app available for their device, and may then not benefit from the features that this medium can offer. Unless the organization has implemented a responsive design within their website, the mobile user may face large download sizes and wildly different user experiences, some of which can be negative.

Downloading a native app from any of these application stores creates a copy of the app's then-current operating code onto the device, making changes in functionality or updating the app an inconvenience that each and every user must then handle individually.

Using the principles of the World Wide Web and with recent developments in web browser-based technologies, it is now easier than before to present websites in ways that are optimized for the capabilities of each different device. Although a web app optimized for a particular mobile device cannot, presently, reliably take advantage of all the features of every such device, a Web developer can now rapidly develop web-apps for any and all mobile devices. Using features of HTML5, web-apps deployed and available through a URI (“Uniform Resource Identifier”) can provide a truly native app-like experience: geo-location provides information local to the user; and local storage of content on the device can greatly speed the experience of the user through the device's offline capability, and so on, without some of the major overheads with native app development.

According to estimates by The International Telecommunication Union (ITU) in 2011, there are about1.2 billion active, mobile-broadband subscriptions in the world (equating to about17 per cent of the 2012 global population). Mobile broadband subscriptions have grown 45 percent annually over the last four years and outnumber fixed broadband subscriptions 2:1. In developed countries, mobile-broadband users often also have a fixed-broadband connection, but in developing countries mobile broadband is often the only access method available.

Many Web users are now mobile-only, that is, they do not, or very rarely also use a desktop, laptop, or tablet computer with a fixed wired connection to access the Web, according to On Device Research. In 2011 over 85 per cent of new mobile telephone handsets will be able to access the mobile Web. Today in the U.S. and Western Europe, 90 per cent of mobile subscribers have an Internet-ready phone.
Gartner (March 2010) predicted that in 2011, over 85 per cent of handsets shipped globally will include some form of browser.
In mature markets, such as Western Europe and Japan, approximately 60 per cent of handsets shipped will be smartphones with sophisticated browsing capabilities.
In mature markets, the mobile Web, along with associated Web adaptation tools, will be a leading technology for business to consumer (B2C) mobile applications through 2012, and should be part of every organization's B2C technology portfolio.
ComScore (February 2011) estimates that 90 per cent of mobile subscribers in the U.S. and Western Europe have a phone that can access the mobile Web. 48 per cent of U.S. and 61 per cent of western Europeans have a handset with an HTML browser (this proportion is increasing fast), the rest have WAP-enabled browsers.
ComScore notes that there are more than 60 different types/versions of mobile browser in use on mobile handsets, making mobile Web design more complicated than traditional desktop Web design.
dotMobi (July 2011) estimated that there are 6,500 distinct Web-capable mobile device models in use, ignoring devices that only vary in color and phones that have been renamed/relabeled by operators, etc. The specifications/features of these devices (particularly screen sizes) vary greatly.
ABI Research (July 2011) predicted that 2.1 billion mobile devices will have HTML5 browsers by 2016 (up from 109 million in 2010). HTML5 will help to deliver a richer, more interactive mobile Web experience, including being able to play video without needing a plug-in such as the Adobe Flash Player.

Viewing a website originally designed for a desktop environment (such as a PC) upon a mobile device through an HTML browser, does not always provide a similar, fulfilling experience in achieving a task that the end user has set out to achieve. Regardless of the screen size of a device, viewing a website that was built for and targeted at desktop users requires users to scroll left/right and up/down. A large number of Web-enabled phones are not smartphones and tend to have much smaller screen sizes. Regardless of the mobile connection's performance, large images are slow to load until 4G and faster networks become commonplace. Many technologies now used on typical desktop websites, such as Flash, simply do not work or do not work well on many handsets, including the current industry leader Apple. Also, mobile Web users have different requirements from desktop Web users and provide different opportunities for which a business can deliver solutions.

With the massive increase now seen in demand for an acceptable experience for mobile content and functionality, delivery by organizations (regardless of their size and scale) to their potential global end users comes the need for a non-technical delivery mechanism for the organization's mobile experience. It is not cost-effective for organizations to develop and maintain multiple, custom developed native mobile applications for each of the continuously expanding mobile platform providers.

There is therefore an opportunity for a new and novel mobile web-app publishing methodology to overcome the drawbacks laid out above that are associated with mobile rendering of desktop environment websites and native mobile application provisioning. The framework built around this mobile web-app publishing methodology provides organizations with a powerful, task-oriented management tool to easily create mobile web applications using content from any back office or web-based data source through a hosted, fully managed cloud mobile service offering.

### SUMMARY OF THE INVENTION

A hosted web application is disclosed from which non-technical management of a mobile website is undertaken. This application has an access-controlled administration interface (web application) which allows for users who wish to manage some aspect of their mobile website administration to do so through the use of the non-technical Graphical User Interface (GUI) provided.

The non-technical, web-based Graphical User Interface (GUI) includes an administration interface that allows for the addition of app-templates as a new app that is deployed within the mobile website. The GUI also enables the configuration, arrangement, and re-ordering of existing apps within current mobile website designs, and affording customization of elements such as the branding and styling that should be consistently used throughout any single mobile website.

A What You See Is What You Get (WYSIWYG) preview interface displays the current configuration in context of an example modern smartphone device, so as to provide instant feedback prior to applying changes to the live audience of end users on their various mobile devices/smartphone devices.

Another facet of this invention resides in the fact that app-templates are used to dramatically speed up and increase the ease by which new functionality can be added to a mobile website.

A selection of base app-templates is provided in this system. Where a need exists to provide additional features and functionality within a mobile website alongside the base-set of app-templates, this need can be met by software developers using the application server's Software Development Kit (SDK). A typical app-template or “Snippet of code” consists of HyperText Markup Language (HTML), eXtensible Markup Language (XML), Javascript, and Cascading Style Sheets (CSS), and it is presented to the non-technical user within an administration panel as an application icon. The non-technical user can now simply find and select the relevant app-template icon to add to a mobile website, and drag it into an available location within the preview area, before providing any necessary configuration for the application to make it function appropriately. For example, with an RSS (Really Simple Syndication) Feed app-template, the non-technical user would simply need to add the Uniform Resource Identifier (URI) for the RSS Feed and save this setting. The app-template will then handle the retrieval and display of this data feed from the configured RSS Feed endpoint.

Another aspect of this invention is the effective management for delivery of updates to end users of the mobile website, whether these are updates to the app-template features and functionality itself, or to the content delivered through the app-template to the end user on their smartphone or other device.

### BRIEF DESCRIPTION OF THE DRAWINGS

FIG. 1 is a plan view of a smartphone device accessing the mobile website homepage as an end user would experience it, showing a set of icons representing individual apps of functionality within the mobile website to allow the end user to perform a particular action or access data provided by the organization.

FIG. 2 is a plan view depicting two alternative ways to navigate into a mobile web-app powered by the present invention, and how the end user may navigate through the organization's web-app to find relevant information or perform tasks enabled by the organization utilizing the present invention for their smartphone users.

FIG. 3 is a plan view depicting a web application interface used to manage the organization's mobile web-app, through which available app-templates are displayed in a library fashion and from which the administrator can select an app-template to non-technically add into a new mobile website by dragging the app-template icon into the mobile phone preview area, for end users to utilize, for example.

FIG. 4 depicts the web application interface used to edit the setup of an existing app that has been added to the organization's website. Upon the app icon's being clicked, the interface displays settings specific to this app-template to allow the administrator to non-technically adjust the setup of the app-template, such as its datasource, icon, name and so on, as determined by the app-template's capabilities.

FIG. 5 depicts a web application interface used to adjust the theme applied to the mobile website from a central, non-technical user interface, with changes showing immediately within the mobile device's preview area.

FIG. 6 depicts the broad structure of the Mobile SAAS invention, whereby customers request the mobile website domain through their mobile device. A Domain Resolver built into the software solution will determine which account is being requested through the use of the domain name assigned to the account. As depicted in the drawing, assuming that a single valid account configuration is located within the service, the mobile website's settings and the apps and their associated settings are collected together and rendered as the mobile website's homescreen, as depicted in FIG. 1. If a specific app icon is tapped from the mobile website's homescreen, and the app requires an outbound connection to a remote data source in order to collect and display data to the end user, and no data has already been collected and cached locally, then a proxy is used within the app-template's connector to achieve this via the developer's desired method of systems interaction e.g. SOAP based webservices, RESTful interfaces, RSS and so on.

FIG. 7 depicts the architectural structure of an app-template in terms of what files are required by an app-template in its upload to the system and day to day operation. The non-technical administrator of the mobile website will not see any of this code, and will only see the default app icon to drag into their preview area, and the app-template configuration options as described within the App Manifest, and rendered through the non-technical administration interface.

FIG. 8 depicts the process of non technically building a data structure and associated source data suitable for publishing as a self-contained app, which once saved will appear within the app library for the administrator to drag into the preview area in order to add it to the mobile website.

FIG. 9 depicts a sample app-template's Manifest file including the XML that powers the configuration requirements of an app-template (as created by a developer), and the resulting user interface provided for the administrator to non-technically configure the app for use within the mobile website. In this example, the Manifest file states that two settings should be provided, one for a “Feed URL” which is required and must validate as a URL, with an optional “Phone number” setting, which has a specific “regex” value to ensure that the administrator provides an input for this setting that meets this basic Regular Expression notation and flags up any obvious errors in their input.

### DETAILED DESCRIPTION OF THE INVENTION

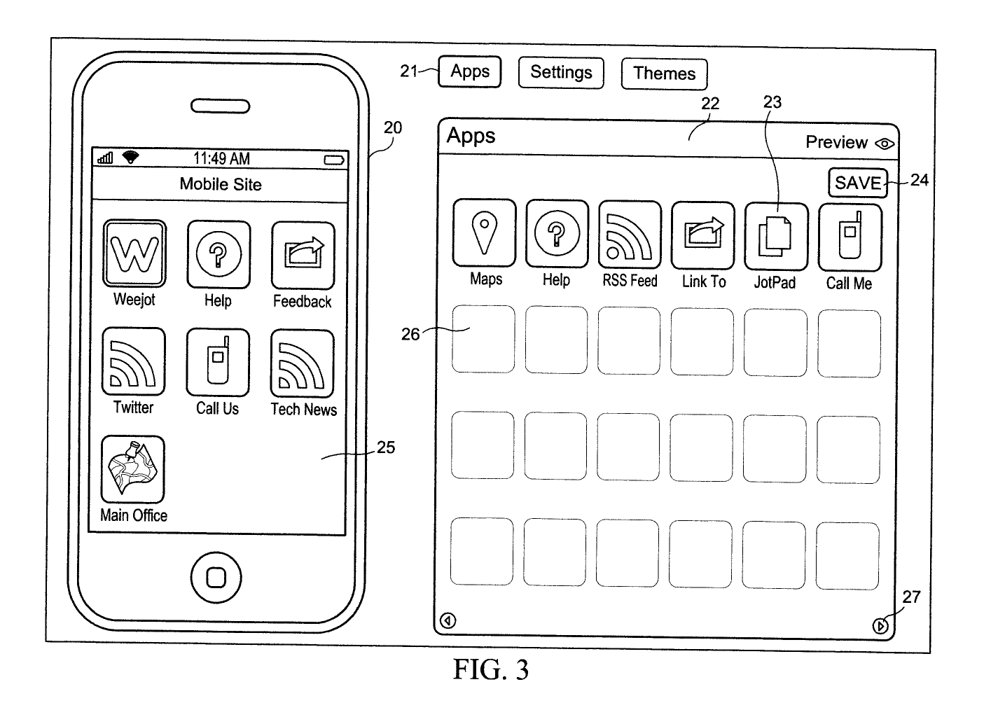

One aspect of the invention regards the hosted web application from which the non-technical management of the mobile website is undertaken by an administrative user. This server based application preferably follows a multi-tenant software as a service (SAAS) architecture, as at 51. The administrator wishing to manage his or her mobile website through this service using the non-technical Graphical User Interface (GUI) would visit the location of the hosted application, and be prompted to log-in to this application via a security feature. Upon successful log-in, the application can retrieve the current account(s) that this administrator is able to administer. Upon selecting the relevant account to be managed, the mobile website's configuration details will be retrieved from the service's data store and presented to the administrator in the form depicted in FIG. 3. Within this administrative interface is a What You See Is What You Get (WYSIWYG) preview area 20 depicted by a modern smartphone device of average screen size.

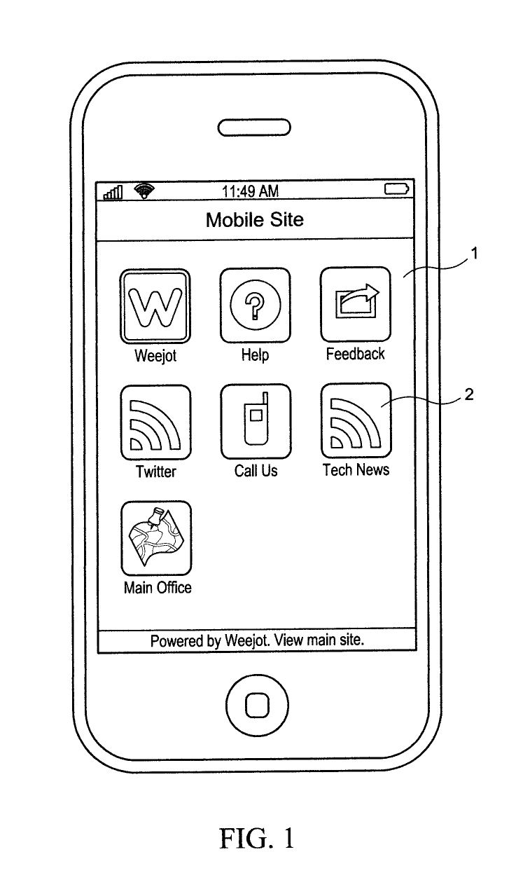

Everything displayed within the preview area 20, from the colors, text, icons, the order of icons, etc. within the WYSIWYG preview interface is the same as how the mobile website will be displayed when accessed through a smartphone device as depicted in FIG. 1 at 1. Slight variations in app icon spacing when viewed upon actual smartphone devices can be expected due to the numerous supported devices and their relevant screen sizes from which the mobile website may be viewed by end users when compared to that of the preview area shown here.

The app library 22, in FIG. 3, displays a list or icon display of all app-templates available for the signed in user. This will consist of all globally-provided app-templates, including those that come as standard as parts of the service, plus any custom app-templates that may have been developed and added by developers through the use of the service's Software Development Kit (SDK), either locally or sourced from a central repository of additional app-templates that may be added to the organization's account. The library may also include app-templates that have previously been configured but removed from active use temporarily; those can easily be re-introduced without the need to re-configure their settings. The administrator can shuttle through multiple pages of available app-templates with control button 27 in FIG. 3. The administrator also may return to the app-template list with the use of the Apps control button, shown at 21.

The Administrator can drag and drop app-template icons, as at 23, from the app library 22 onto a spare app space within the preview area 25, allowing new features and functionality to be added non-technically to the mobile website with ease. A save action 24 can be clicked to import or save changes to the actual mobile website from within the app studio.

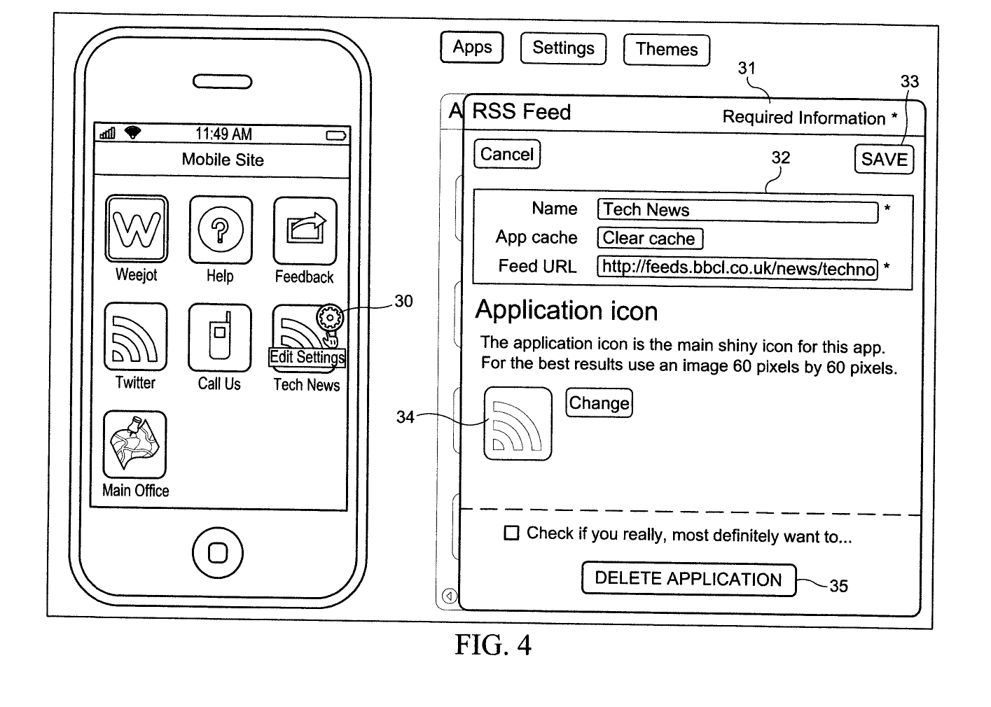

An app icon displayed within the preview area 25 in FIG. 3 can be clicked as at 30 in FIG. 4 by the Administrator in order to allow review or to configure any specific functional settings that the relevant app may have, as at 32. The exact nature of the app-template's configuration options will depend upon the underlying code and functionality for the particular app-template that is clicked. At 31 in FIG. 4, for instance, all the configuration options available for the “RSS Feed” app-template, including Name, a Feed URL, and a “cancel” button to clear the application cache for this particular example. The administrator should save as at 33 their app-template configuration options once complete. The result is an app icon displayed within the mobile website 2, in FIG. 1, that functions as if it were a native application, providing access to content from a third-party source.

The administrator can easily re-order, edit, and/or remove icons from within the preview area 20 by simply drag-and-dropping the icon within the preview area 20, in FIG. 3, or by dragging the icon out of the preview area back into a blank position within the app-template library 26. An existing app icon can be completely removed from the system by clicking button 35, as in FIG. 4.

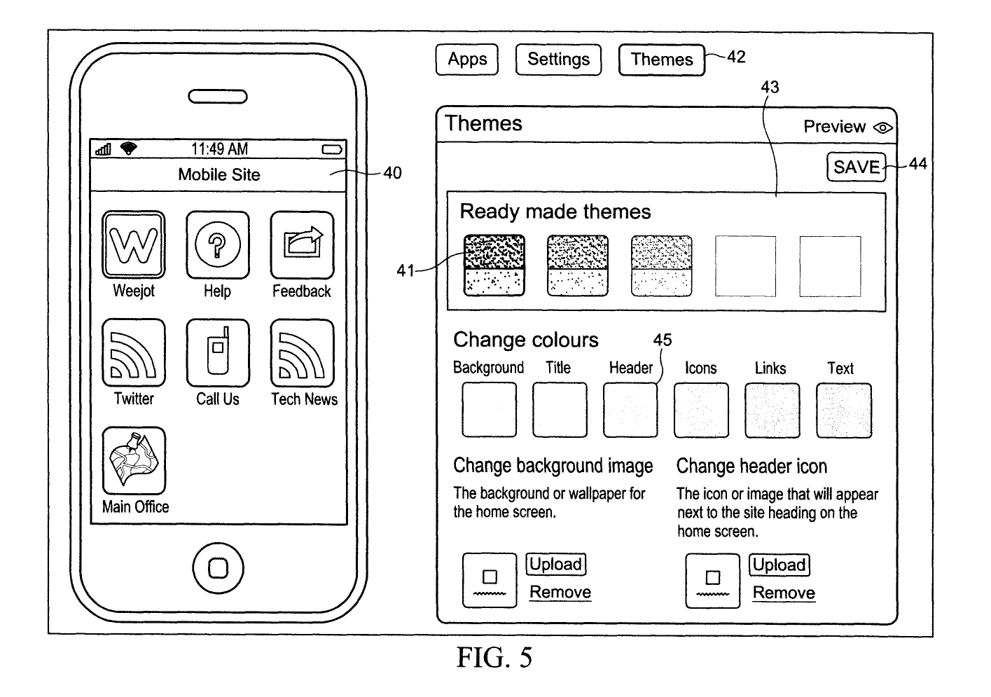

Cascading style sheets (CSS) are used to provide consistent styling across all app-templates that are deployed within an organization's mobile website. In order to continue with the non-technical management of the mobile website, the administrator does not need to know or understand CSS in order to re-brand or style or theme their mobile website. By accessing Themes 42 in FIG. 5, the administrator can very easily change the current color scheme displayed in the application. The administrator can choose to apply one of the ready made themes as at 41 from the available collection 43, with immediate effect within preview window 40. The administrator can also choose to change individual color settings, such as, but not limited to, Background, Title, Header, Icons, Links, Text by clicking 45 to load a non-technical color selection user interface. The administrator may also change other stylistic settings such as the header icon or mobile website background image. A save button 44 can be clicked to save changes to the actual mobile website theme from within the app studio.

In distinction from native apps which are built using specific programming languages and libraries for their target device (Apple iOS apps would be developed using the Objective-C language, Google Android and RIM Blackberry use Java, and so on), app-templates provided according to this invention consist of a number of files commonly used in web development practices, including HyperText Markup Language (HTML), eXtensible Markup Language (XML), and Javascript. This feature allows app-template developers to work in a more commonly available set of tools and existing skillsets without the need to be trained in the specifics of each device's native development language.

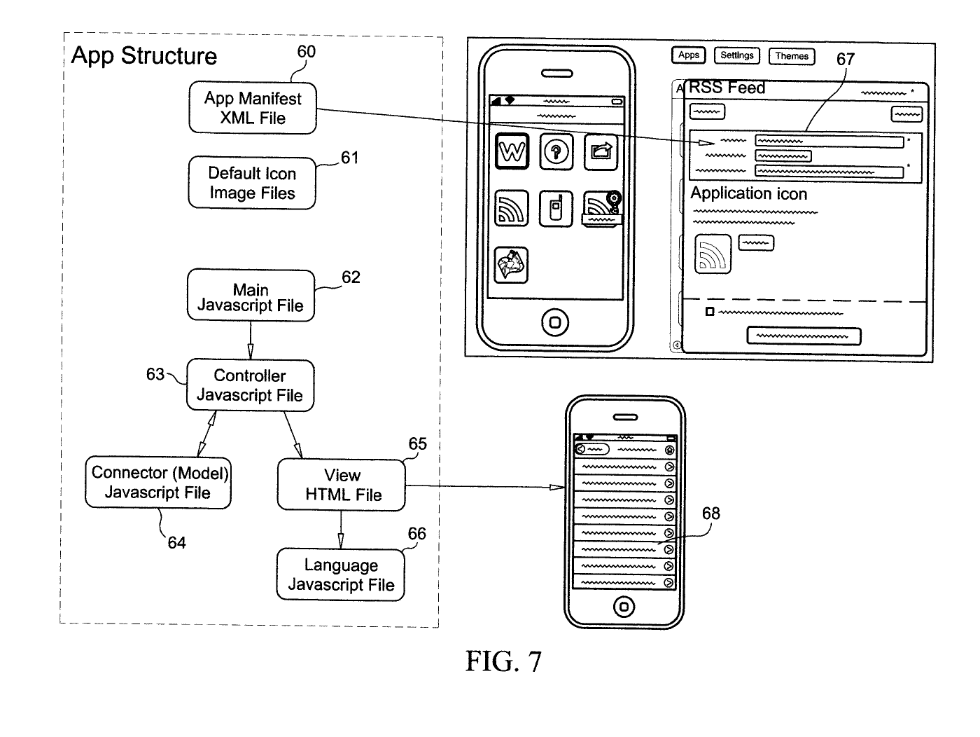

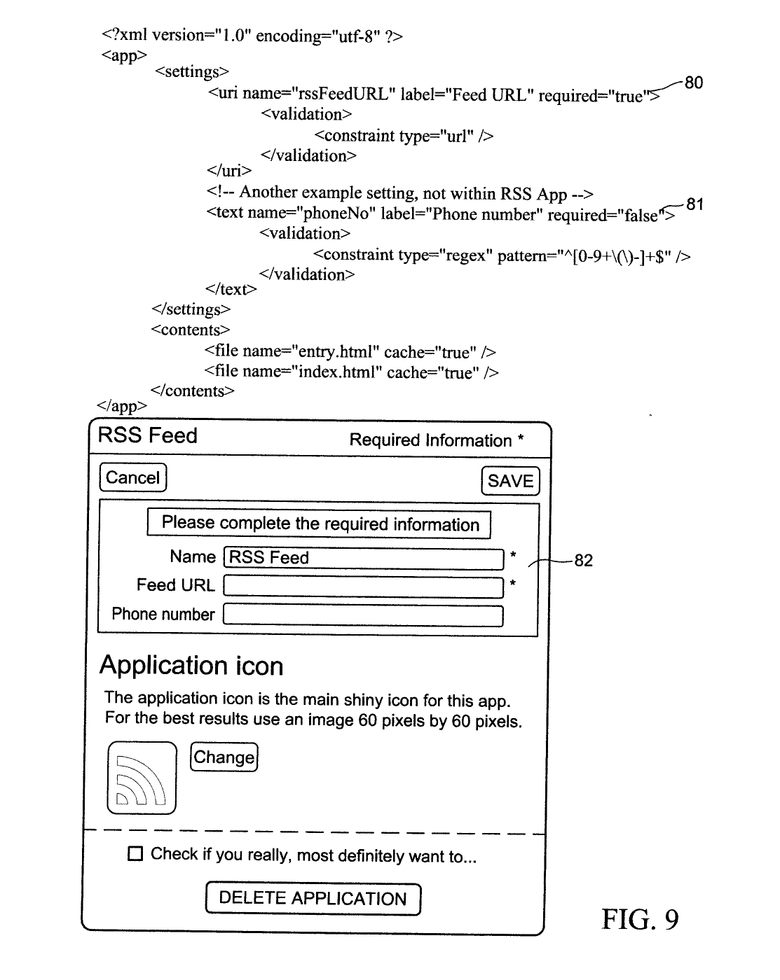

The architecture of an app-template is depicted in FIG. 7; it broadly follows the Model View Controller (MVC) paradigm. The App Manifest file 60 is an XML file that describes the settings and the contents of a specific app-template. The settings XML element 80, in FIG. 9, is an optional element that defines the settings expected by the app code and any validation required over the administrator's input before allowing these settings to be applied. When an administrator adds this specific app-template to their mobile website, he or she will be presented with a HTML form representation 67, in Fog. 7, to enter values in a non-technical way. Various setting types will exist to allow the web administration interface to make configuring the app-template as easy and non-technical as possible. The programming at 81, FIG. 9 again, shows how another setting could be added to the RSS Feed app-template to collect a phone number from the administrator for use within the app-template logic itself, and how this additional field would then be reflected within the settings for input user interface 82.

The “main.js” file 62, in FIG. 7, is used to initialize the app when requested by the end user, by clicking on its icon from the mobile website homepage. The tasks that this file should undertake include initialization tasks, for example creating controllers and application state; creating routes used to link controllers to particular actions; create views and attach actions to elements within a view; add routes for each app screen and a controller function for each route; and so on. This file is never seen by the administrative user, but would only be seen by a developer who is creating a new type of app-template for the administrator to utilize.

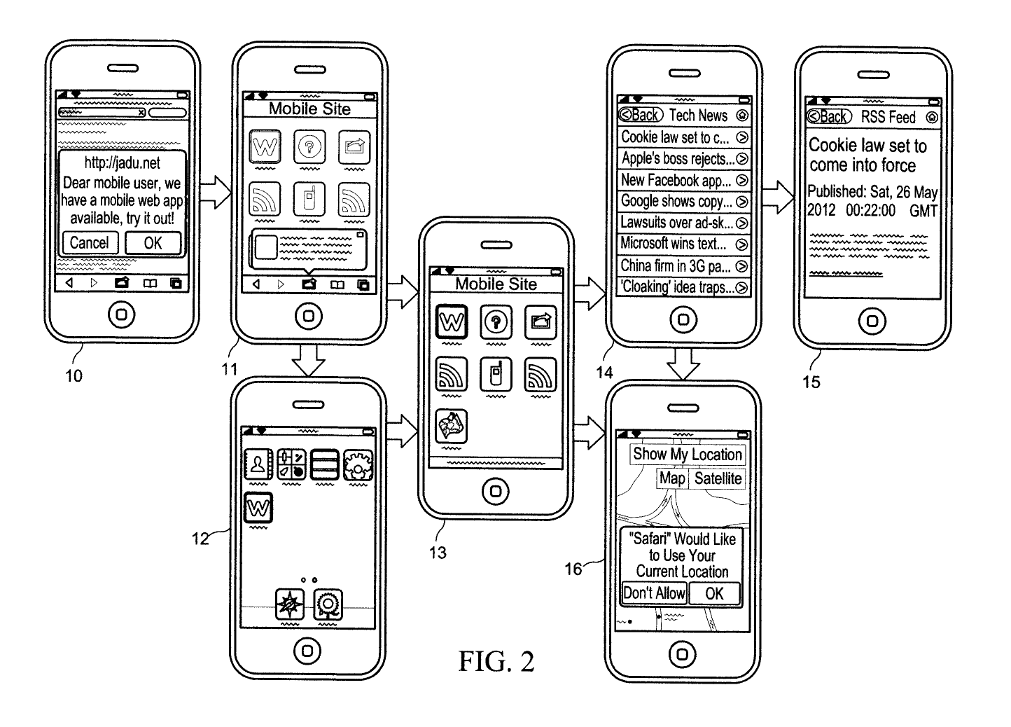

The Controller 63, still in FIG. 7, interprets the actions of the end user as he or she makes them within the app, causing the model and/or the view to change as necessary, for instance when tapping into the RSS feed news item at 14 in FIG. 2, so that the view at 15 can be rendered to the end user to see the details of the item tapped.

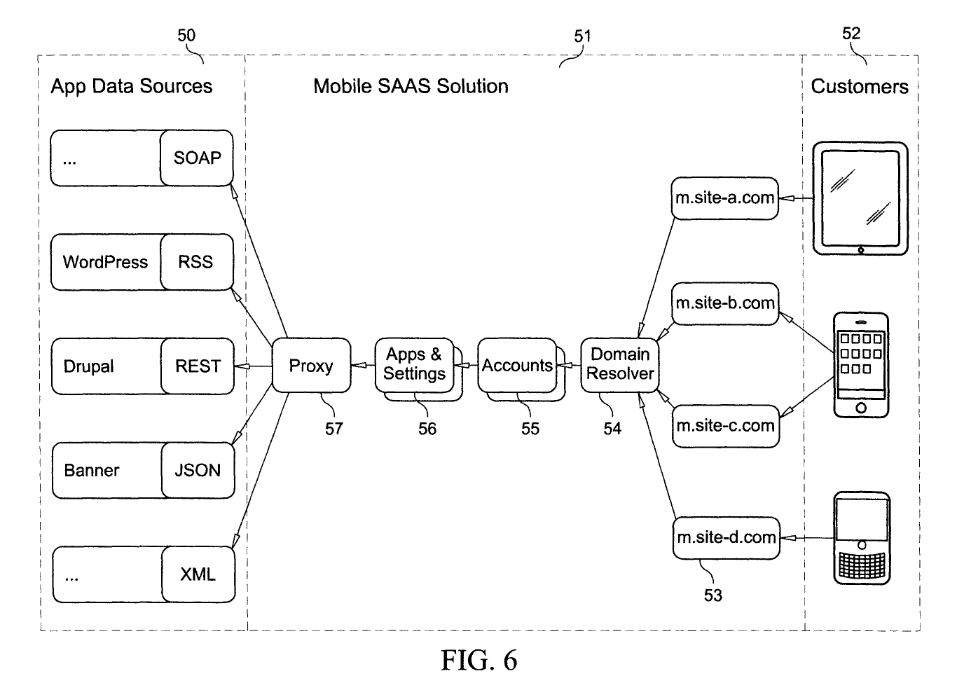

Connectors 64, in FIG. 7, allow the developer to access data from remote systems within the app, using techniques such as web services via Simple Object Access Protocol (SOAP) or Representational State Transfer (REST) as depicted at 50 in FIG. 6. To circumvent the Javascript same origin policy, a central proxy service is provided 57in FIG. 6, through which to retrieve data. By convention, connectors should be placed within a Connectors directory within such an app package.

The view 65 of output template file, in FIG. 7, contains the HTML output shown at 68 that will be sent back to the device upon accessing the app from the mobile website homepage. It is also possible for data generated via the controller 63 to be output through the mobile device. The view at 68 can utilize strings of text as defined within the Language Javascript File 66 in order to provide Internationalization support to the mobile website, whereby a translated alternative specific to a given spoken language is provided within this file and replaced at the point of rendering the view for the end user, since the program has determined the most appropriate locale for the end user, either by end user choice or through a means of detection through values provided by the end user's web browser in their mobile device.

In addition to this collection of files that are used to provide the underlying functionality of the app-template, there is also an initial default app icon contained within the app-template 61 in FIG. 7 that is used to allow the administrative user to easily identify the app-template from within the app-template library. The default icon can later be changed to one that the administrator deems more suitable for their current use of this app-template through the app-template configuration options area 34, shown in FIG. 4.

New app-templates conforming to the structures disclosed above can be ZIP archived and uploaded through the developer interface of the web administration panel, to appear within the app-template library 22, in FIG. 3. Alternatively, the app-templates can be built within the app-template developer interface directly.

Once a mobile website has been configured and deployed through such a service, the end user would initially access the mobile website through their smartphone's web browser of choice. They may be prompted to the existence of the mobile website of the organization when accessing the organization's primary website, at which point the website infrastructure may be set to detect the end user's browser's user-agent (e.g. Internet Explorer, Firefox, Windows, iOS, and so on) and prompt the user to access their specialized mobile service instead of the desktop oriented website as in 10. Alternatively, the organization may have promoted the mobile website as advertising upon the standard website, or in supplemental advertising material or search engines.

Upon accessing the mobile website, the end user is prompted, as at 11 in FIG. 2, to add the mobile website to their device's home screen 12, in FIG. 2. Most modern smartphones offer this facility, which will then allow the mobile website to appear alongside other native-apps within the smartphone's home screen(s), as shown in 12.

The mobile website's home screen 13, in FIG. 2, provides the end user access to each of the apps, displayed as icons, providing relevant features and functionality as configured by the organization's administrator(s). At 14, the end user has tapped the “Tech News” app icon and has, as a result, had a list of news articles from the RSS Feed displayed and configured within the RSS app-template, the source of which may or may not be managed by the web-app administrator. The end user can now scroll through the list of feed items to find a relevant news item. Up-on clicking this item's title as at 14, the user interface changes to display details of the users' chosen news item, as in the screen 15. After having read the news item, the user may next navigate back to the main mobile website home screen 13, and choose to use a different app, such as the “Main office” app, powered by the Maps app-template. Upon doing so, the end user could be prompted to check if the app is allowed to obtain the end user's current location 16 (using HTML5's geo-location capabilities), so that this would also be displayed upon the map, should the end user wish the app to do so.

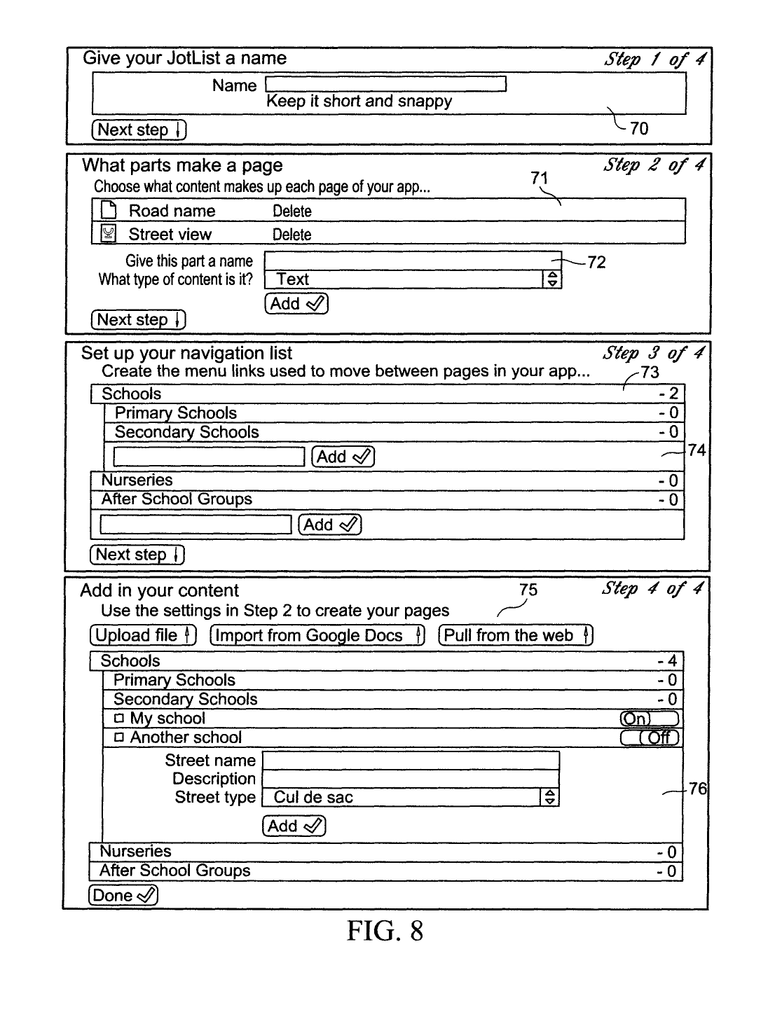

The first step 70 in non technically building a data structure and associated source data suitable for publishing as a self-contained app within the mobile website, as at FIG. 8, is to give the data collection that is to be exposed a name for ease of identification purposes. The second step is to then define the individual fields of data that are to be included in any given record with-in the data collection, as at 72. Existing fields can be adjusted, removed, moved as necessary, as at 71. The third step is to define the hierarchy for the grouping of data, as at 73, by adding child categories to any existing category structure, as shown at 74. In the example shown in FIG. 8, a top level “Schools” category has been broken down into “Primary Schools” and “Secondary Schools” sub-categories so that data records can then be classified within the appropriate areas. This will result in a list view within the end user interface when displayed upon a mobile device as at 14, in FIG. 2, which the end user can drill down through until they reach the relevant data record. These categories could be infinitely deep.

The subsequent step is then to define the actual source data records that the user is trying to find out about, i.e. specific data about the school in this example. This data could be imported from an external source, such as the upload of a static CSV/XLS file or from an external service such as a Google Docs Spreadsheet, as at 75 in FIG. 8. This could also be created inline as at 76 (in accordance with the record structure specified in the second step 71), within the category structure 73 (as specified in the third step) for each individual data record in turn. When this data collection is ready, it can be saved as a new app within the library 22, in FIG. 3, so that it can be dragged into and out of the mobile web preview 25 for end user access to this data.

Upon accessing content provided through the apps within the mobile website, data will be cached within HTML5's Local Storage capability (assuming that the user has not opted out of allowing local storage use) in order to allow the end user to access data that they have previously downloaded without needing to fetch it from the data source upon each refresh/request. This provides access to previously visited content when no 3G or better connection is available, such as when an end user finds himself or herself with poor mobile telephony coverage/reception. This content would have a limited lifespan configurable within the web administration application.

The complexity around data storage upon the end user's device and the temporary caching of remote data is handled by the service without the mobile website administrator's needing to configure or control this in any direct way, further assisting in the non-technical creation and management of these mobile websites.

When a request for a mobile website hosted by this service is received, as at 53, from end user devices 52, the Domain Resolver 54 will handle the request in order to determine the relevant account 55 from this multi-tenant software as a service solution. Once the account is known, the various details of the account are retrieved as at 56 in FIG. 6, such as the apps that make up the mobile website and their associated settings, the theme applied to the mobile website, and so on. This will provide enough information for the mobile website homepage, including icons for each of the contained apps to be rendered to the requesting mobile device. From the homepage, the end user may then enter into an app by clicking its icon. Depending upon the app's functionality, this may have a connector to an external data source by the preferred method of systems interaction e.g. SOAP based web services, RESTful interfaces, RSS. Where this is the case, the service's Proxy 57 can be used to make the request to the remote service(s) 50. The Proxy can then be used to temporarily cache the raw data returned from the data source to minimize unnecessary network traffic in order to keep performance optimal during high traffic periods. The final data that is used by the app itself can be stored locally upon the end user's device using HTML5 Local Storage (where the end user has not opted out of this capability) for continued app usage during times of lost network connectivity (Wifi, 3G, or other network capabilities). Only data that have previously been successfully returned would be stored. Therefore, an end user would be able to access data that they have previously requested at a time of no network connectivity. As soon as network connectivity is available, and the age of the local stored data is greater than the period for which data shall be stored, then the Local Storage shall be invalidated so that the next time the end user visits this app, they shall collect fresh data to be stored locally again.

If the app's structure itself should need to change (for example a service update is required to push a new feature to a particular app included within the mobile website implementation), then the service would provide a lightweight method for the mobile website to check if the local cache of data and app-code currently stored upon the mobile device has changed since it was last retrieved from the service via a token mechanism. The cache token would be provided upon request from the device to the mobile website. If the cache stored locally has expired, and does not match that of the one currently available on the application server, then an update is available, and the user is prompted to request the latest version of app-code from the application server.

Although various modifications and changes can be made to the steps, methods, and principles of the invention as disclosed, the scope of the invention is broad and limited only by the language of the appended claims.

What we claim as our invention is:

1. A method for creating and maintaining a mobile website application, the method comprising the steps,
a. configuring and displaying on an administrative interface on a device at least one available app-template providing designated functionality, the app-template being selected from a group comprising at least a map, a link to information, and a directory of data;
b. selecting at least one of a plurality of app-templates [represented by graphic or other icons] from a library thereof; and
c. updating the information by at least one of creating, adding, modifying, and supplementing same under at least one of the available app-templates.

2. The method defined in claim 1, further comprising the step of providing at least one new app-template to said administrative interface for assisting the administrative user in the addition of new types of functionality to the app-template library.

3. The method defined in claim 1, further comprising the step of creating an app for use within a mobile website by creating content structure and sourcing data associated therewith.

4. The method defined in claim 1, wherein the library of app-templates is sourced from a location other than the account's base library and any additions thereto, including from a shared, networked, third-party library of apps.
